(19) United States
(12) Patent Application Publication
(10) Pub. No.: US 2011/0043689 A1
(43) Pub. Date: Feb. 24, 2011

(54) FIELD-OF-VIEW CHANGE DETECTION

(76) Inventors: Wesley Kenneth Cobb, The Woodlands, TX (US); Dennis Gene Urech, Katy, TX (US); Bobby Ernest Blythe, Houston, TX (US); Rajkiran Kumar Gottumukkal, Houston, TX (US); Kishor Adinath Saitwal, Houston, TX (US); Tao Yang, Katy, TX (US); Lon William Risinger, Katy, TX (US)

Correspondence Address: PATTERSON & SHERIDAN, L.L.P., 3040 POST OAK BOULEVARD, SUITE 1500, HOUSTON, TX, 77056, US

(21) Appl. No.: 12/543,281

(22) Filed: Aug. 18, 2009

(51) Int. Cl. H04N 9/74; H04N 7/01

(52) U.S. Cl. 348/453; 348/578; 348/580; 348/E09.055; 348/E07.003

(57) ABSTRACT

Techniques are disclosed for detecting a field-of-view change for a video feed. These techniques differentiate between a new or changed scene and a temporary variation in the scene to accurately detect field-of-view changes for the video feed. A field-of-view change is detected when the position of a camera providing the video feed changes, the video feed is switched to a different camera, the video feed is disconnected, or the camera providing the video feed is obscured. A false-positive field-of-view change is not detected when the scene changes due to a sudden variation in illumination, obstruction of a portion of the camera providing the video feed, blurred images due to an out-of-focus camera, or a transition between bright and dark light when the video feed transitions between color and near infrared capture modes.

### BACKGROUND OF THE INVENTION

1. Field of the Invention

Embodiments of the invention provide techniques for detecting a field-of-view change for a video feed. More specifically, embodiments of the invention relate to techniques for differentiating between a new or changed scene and a temporary variation in the scene to accurately detect field-of-view changes for the video feed.

2. Description of the Related Art

Some currently available video surveillance systems provide simple object recognition capabilities. For example, a video surveillance system may be configured to classify a group of pixels (referred to as a “blob”) in a given frame as being a particular object (e.g., a person or vehicle). Once identified, a “blob” may be tracked frame-to-frame in order to follow the “blob” moving through the scene over time, e.g., a person walking across the field of vision of a video surveillance camera. Further, such systems may be configured to determine when an object has engaged in certain predefined behaviors.

However, such surveillance systems typically require that the objects and/or behaviors which may be recognized by the system to be defined in advance. Thus, in practice, these systems rely on predefined definitions for objects and/or behaviors to evaluate a video sequence. In other words, unless the underlying system includes a description for a particular object or behavior, the system is generally incapable of recognizing that behavior (or at least instances of the pattern describing the particular object or behavior). Thus, what is “normal” or “abnormal” behavior needs to be defined in advance, and separate software products need to be developed to recognize additional objects or behaviors. This results in surveillance systems with recognition capabilities that are labor intensive and prohibitively costly to maintain or adapt for different specialized applications. Accordingly, currently available video surveillance systems are typically unable to recognize new patterns of behavior that may emerge in a given scene or recognize changes in existing patterns. More generally, such systems are often unable to identify objects, events, behaviors, or patterns as being “normal” or “abnormal” by observing what happens in the scene over time; instead, such systems rely on static patterns defined in advance.

In order for the system to recognize objects and/or behavior a background scene is separated from the foreground objects in the scene. Particular background scenes may be defined in advance or captured during surveillance and the system may search a database of scene presets to match a current background scene and load a corresponding background model. Changes in lighting and partial obstruction of the scene may interfere with the system's ability to detect whether or not a field-of-view change has occurred. When a field-of-view change is falsely detected a new background model is generated and any learning that was achieved for the scene is redeveloped. Accordingly, what is needed is a technique for detecting a field-of-view change that is able to differentiate between a new or changed scene and a temporary variation in the scene to accurately detect field-of-view changes for the video feed.

### SUMMARY OF THE INVENTION

Advantageously, techniques described herein may be used for detecting a field-of-view change for a video feed. Doing so allows a computer vision engine to differentiate between a new (or changed) scene and a temporary variation in the scene. That is, the techniques described herein may be used to accurately detect field-of-view changes for a video feed. When a field-of-view change is detected, a background model corresponding to the new position is identified (if available) and any learning that was previously generated by a machine-learning engine may be restored. Otherwise, a new camera preset is created. This ability to continue the learning process for a previously used camera position (rather than start over each time the field-of-view changes) improves the ability of the system to quickly classify objects and behaviors as well as to learn from previously observed patterns to distinguish between normal and abnormal events.

One embodiment of the invention includes a computer-implemented method for detecting a field-of-view change for a video feed. The method may generally include receiving a stable background scene acquired from a plurality of images of the video feed, receiving a new image from the video feed, and converting the stable background scene to a gray scale representation to produce a converted stable background scene. Features representing image characteristics are extracted from the converted stable background scene to produce extracted features, where each extracted feature is associated with a position of a pixel. A field-of-view change signal is produced that indicates if a field-of-view change has occurred in the video feed based on the extracted features, the converted stable background scene, and the new image.

Another embodiment of the invention includes a computer-readable storage medium containing a program which, when executed by a processor, performs an operation for detecting a field-of-view change for a video feed. The operation may generally include receiving a stable background scene acquired from a plurality of images of the video feed, receiving a new image from the video feed, and converting the stable background scene to a gray scale representation to produce a converted stable background scene. Features representing image characteristics are extracted from the converted stable background scene to produce extracted features, where each extracted feature is associated with a position of a pixel. A field-of-view change signal is produced that indicates if a field-of-view change has occurred in the video feed based on the extracted features, the converted stable background scene, and the new image.

Still another embodiment includes a system having a video input source configured to capture images received through a video feed, a processor, and a memory. The memory contains a program, which, when executed on the processor is configured to perform an operation for. The operation comprises receiving a stable background scene acquired from an image of the video feed, receiving a stable background scene acquired from a plurality of images of the video feed and also include converting the stable background scene to a gray scale representation to produce a converted stable background scene. Features representing image characteristics are extracted from the converted stable background scene to produce extracted features, where each extracted feature is associated with a position of a pixel. A field-of-view change signal is produced that indicates if a field-of-view change has occurred in the video feed based on the extracted features, the converted stable background scene, and the new image.

### BRIEF DESCRIPTION OF THE DRAWINGS

So that the manner in which the above recited features, advantages, and objects of the present invention are attained and can be understood in detail, a more particular description of the invention, briefly summarized above, may be had by reference to the embodiments illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates components of a video analysis and behavior-recognition system, according to one embodiment of the invention.

FIG. 2 illustrates components of a computer vision engine and of a machine learning engine, according to one embodiment of the present invention.

FIG. 3A illustrates an image captured by a camera, according to one embodiment of the invention.

FIG. 3B illustrates the background scene of the image shown in FIG. 3A, according to one embodiment of the invention.

FIG. 3C illustrates the background scene shown in FIG. 3B under different lighting conditions, according to one embodiment of the invention.

FIG. 3D illustrates a changed field-of-view including a portion of the background scene shown in FIG. 3B, according to one embodiment of the invention.

FIG. 3E illustrates a partially obstructed view of the background scene shown in FIG. 3B, according to one embodiment of the invention.

FIG. 4A illustrates components of the BG/FG component shown in FIG. 2, according to one embodiment of the present invention.

FIG. 4B illustrates a method for detecting a field-of-view change, according to one embodiment of the invention.

FIG. 4C illustrates a method for extracting features from a stable background scene or updated stable background scene, according to one embodiment of the invention.

FIG. 5A illustrates a method for determining if a camera movement threshold is exceeded and changed the field-of-view, according to one embodiment of the invention.

FIG. 5B illustrates a method for determining if matching results indicate a change in scene illumination or a blurred scene and a field-of-view change has not occurred, according to one embodiment of the invention.

FIG. 5C illustrates a method for determining if phase matching results indicate that the scene is obstructed and a field-of-view change has not occurred, according to one embodiment of the invention.

FIG. 6 illustrates a method for using the field-of-view-detection to save and restore learning developed for a scene, according to one embodiment of the invention.

### DETAILED DESCRIPTION OF THE PREFERRED EMBODIMENTS

Embodiments of the invention provide a behavior-recognition system configured to identify, learn, and recognize patterns of behavior by observing and evaluating events depicted by a sequence of video frames. In a particular embodiment, the behavior-recognition system may include both a computer vision engine and a machine learning engine. The computer vision engine may be configured to receive and evaluate a stream of video frames. Each frame may include data representing the color, grayscale, and/or intensity values for each pixel in the frame. A frame of video may be characterized using multiple color channels (e.g., a radiance value between 0-255 and a set of red, green, and blue (RGB) color channels values, each between 0-255). Further, the computer vision engine may generate a background scene by observing the scene over a number of video frames. For example, consider a video camera trained on a stretch of a highway. In such a case, the background scene would include the roadway surface, the medians, any guard rails or other safety devices, and traffic control devices, etc., that are visible to the camera. Vehicles traveling on the roadway (and any other person or thing engaging in some activity) that are visible to the camera would represent scene foreground objects.

The computer vision engine may compare the pixel values for a given frame with the background scene and identify objects as they appear and move about the scene. Typically, when a region of the scene (referred to as a “blob” or “patch”) is observed with appearance values that differ substantially from the background scene, that region is identified as depicting a foreground object. Once identified, the object may be evaluated by a classifier configured to determine what is depicted by the foreground object (e.g., a vehicle or a person). Further, the computer vision engine may identify features (e.g., height/width in pixels, average color values, shape, area, and the like) used to track the object from frame-to-frame. Further still, the computer vision engine may derive a variety of information while tracking the object from frame-to-frame, e.g., position, current (and projected) trajectory, direction, orientation, velocity, acceleration, size, color, and the like. In one embodiment, the computer vision outputs this information as a stream of “context events” describing a collection of kinematic information related to each foreground object detected in the video frames.

Data output from the computer vision engine may be supplied to the machine learning engine. In one embodiment, the machine learning engine may evaluate the context events to generate “primitive events” describing object behavior. Each primitive event may provide some semantic meaning to a group of one or more context events. For example, assume a camera records a car entering a scene, and that the car turns and parks in a parking spot. In such a case, the computer vision engine could initially recognize the car as a foreground object; classify it as being a vehicle, and output kinematic data describing the position, movement, speed, etc., of the car in the context event stream. In turn, a primitive event detector could generate a stream of primitive events from the context event stream such as “vehicle appears,” vehicle turns,” “vehicle slowing,” and “vehicle stops” (once the kinematic information about the car indicated a speed of 0). As events occur, and re-occur, the machine learning engine may create, encode, store, retrieve, and reinforce patterns representing the events observed to have occurred, e.g., long-term memories representing a higher-level abstraction of a car parking in the scene—generated from the primitive events underlying the higher-level abstraction. Further still, patterns representing an event of interest may result in alerts passed to users of the behavioral recognition system.

In one embodiment, the machine learning engine may include a mapper component configured to parse data coming from the context event stream and the primitive event stream and to supply portions of these streams as input to multiple Adaptive Resonance Theory (ART) networks. Each individual ART network may generate clusters from the set of inputs data specified for that ART network. Each cluster represents an observed statistical distribution of a particular thing or event being observed that ART network. Further, the mapper component may be configured to detect unusual events occurring in the scene depicted by the video frames. For example, the mapper component may monitor the clusters that emerge a given one of the ART networks, and in some cases, when a set of inputs results in a new cluster, generate an alert representing the occurrence of an unusual event.

In the following, reference is made to embodiments of the invention. However, it should be understood that the invention is not limited to any specifically described embodiment. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Examples of computer-readable storage media include (i) non-writable storage media (e.g., read-only memory devices within a computer such as CD-ROM or DVD-ROM disks readable by an optical media drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other examples media include communications media through which information is conveyed to a computer, such as through a computer or telephone network, including wireless communications networks.

In general, the routines executed to implement the embodiments of the invention may be part of an operating system or a specific application, component, program, module, object, or sequence of instructions. Computer programs implementing embodiments of the invention typically include source code instructions compiled (or interpreted) into a machine-readable format and hence executable instructions. Also, programs include variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

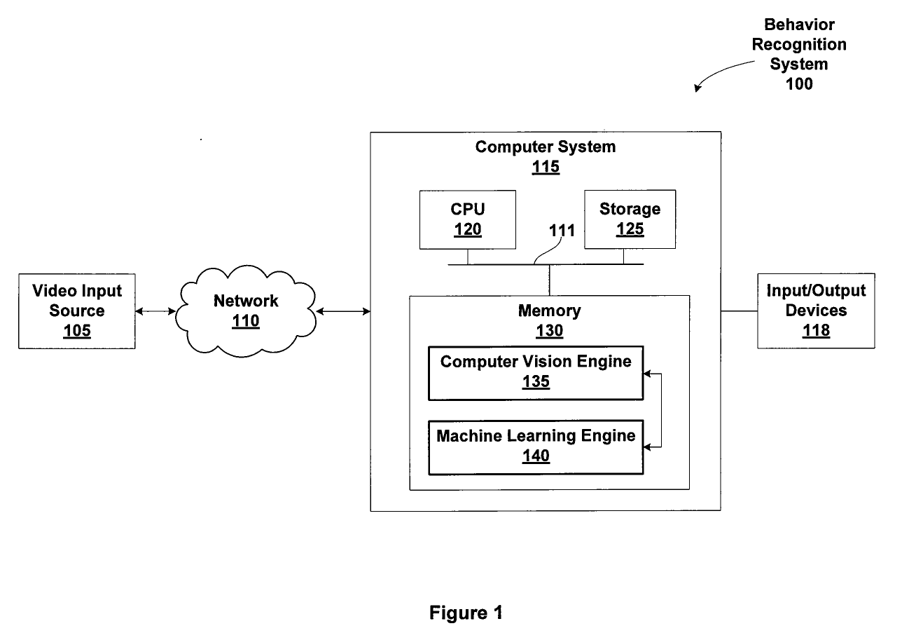

FIG. 1 illustrates components of a video analysis and behavior-recognition system 100, according to one embodiment of the present invention. As shown, the behavior-recognition system 100 includes a video input source 105, a network 110, a computer system 115, and input and output devices 118 (e.g., a monitor, a keyboard, a mouse, a printer, and the like). The network 110 may transmit video data recorded by the video input 105 to the computer system 115. Illustratively, the computer system 115 includes a CPU 120, storage 125 (e.g., a disk drive, optical disk drive, floppy disk drive, and the like), and a memory 130 containing both a computer vision engine 135 and a machine learning engine 140. As described in greater detail below, the computer vision engine 135 and the machine learning engine 140 may provide software applications configured to analyze a sequence of video frames provided by the video input 105.

Network 110 receives video data (e.g., video stream(s), video images, or the like) from the video input source 105. The video input source 105 may be a video camera, a VCR, DVR, DVD, computer, web-cam device, or the like. For example, the video input source 105 may be a stationary video camera aimed at a certain area (e.g., a subway station, a parking lot, a building entry/exit, etc.), which captures the events taking place therein. Generally, the area visible to the camera is referred to as the “scene.” The video input source 105 may be configured to capture the scene as a sequence of individual video frames at a specified frame-rate (e.g., 24 frames per second), where each frame includes a fixed number of pixels (e.g., 320×240). Each pixel of each frame may specify a color value (e.g., an RGB value) or grayscale value (e.g., a radiance value between 0-255). Further, the video stream may be formatted using known such formats e.g., MPEG2, MJPEG, MPEG4, H.263, H.264, and the like.

The computer vision engine 135 may be configured to analyze this raw information to identify active objects in the video stream, classify the objects, derive a variety of metadata regarding the actions and interactions of such objects, and supply this information to a machine learning engine 140. In turn, the machine learning engine 140 may be configured to evaluate, observe, learn and remember details regarding events (and types of events) that transpire within the scene over time.

In one embodiment, the machine learning engine 140 receives the video frames and the data generated by the computer vision engine 135. The machine learning engine 140 may be configured to analyze the received data, build semantic representations of events depicted in the video frames, detect patterns, and, ultimately, to learn from these observed patterns to identify normal and/or abnormal events. Additionally, data describing whether a normal/abnormal behavior/event has been determined and/or what such behavior/event is may be provided to output devices 118 to issue alerts, for example, an alert message presented on a GUI interface screen. In general, the computer vision engine 135 and the machine learning engine 140 both process video data in real-time. However, time scales for processing information by the computer vision engine 135 and the machine learning engine 140 may differ. For example, in one embodiment, the computer vision engine 135 processes the received video data frame-by-frame, while the machine learning engine 140 processes data every N-frames. In other words, while the computer vision engine 135 analyzes each frame in real-time to derive a set of information about what is occurring within a given frame, the machine learning engine 140 is not constrained by the real-time frame rate of the video input.

Note, however, FIG. 1 illustrates merely one possible arrangement of the behavior-recognition system 100. For example, although the video input source 105 is shown connected to the computer system 115 via the network 110, the network 110 is not always present or needed (e.g., the video input source 105 may be directly connected to the computer system 115). Further, various components and modules of the behavior-recognition system 100 may be implemented in other systems. For example, in one embodiment, the computer vision engine 135 may be implemented as a part of a video input device (e.g., as a firmware component wired directly into a video camera). In such a case, the output of the video camera may be provided to the machine learning engine 140 for analysis. Similarly, the output from the computer vision engine 135 and machine learning engine 140 may be supplied over computer network 110 to other computer systems. For example, the computer vision engine 135 and machine learning engine 140 may be installed on a server system and configured to process video from multiple input sources (i.e., from multiple cameras). In such a case, a client application 250 running on another computer system may request (or receive) the results over network 110.

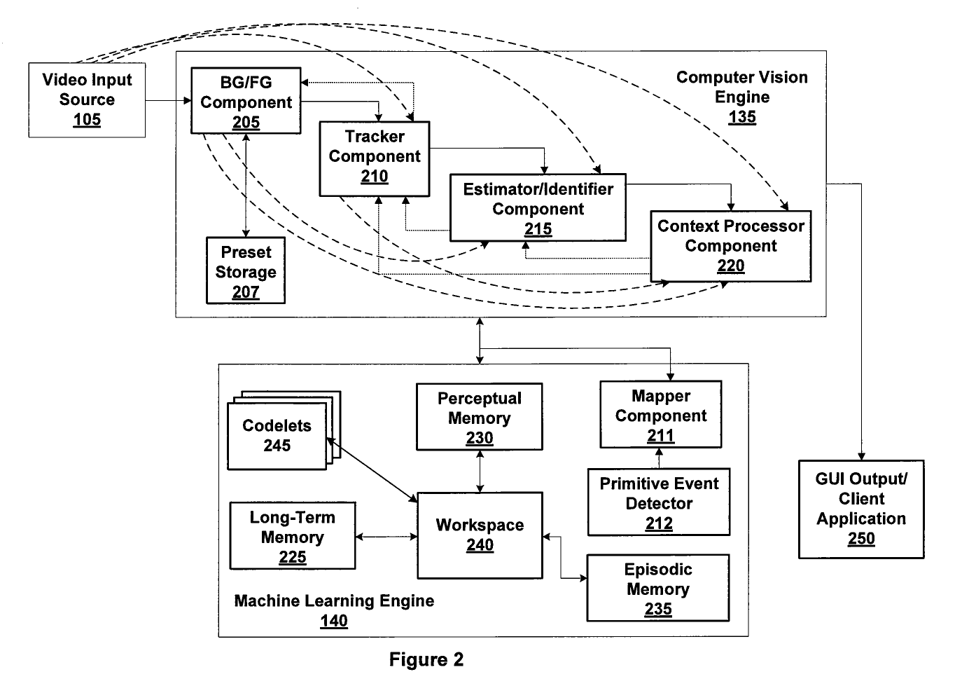

FIG. 2 further illustrates components of the computer vision engine 135 and the machine learning engine 140 first illustrated in FIG. 1, according to one embodiment of the present invention. As shown, the computer vision engine 135 includes a background/foreground (BG/FG) component 205 and associated preset storage 207, a tracker component 210, an estimator/identifier component 215, and a context processor component 220. Collectively, the components 205, 210, 215, and 220 provide a pipeline for processing an incoming video feed that is a sequence of video frames supplied by the video input source 105 (indicated by the solid arrows linking the components). Additionally, the output of one component may be provided to multiple stages of the component pipeline (as indicated by the dashed arrows). In one embodiment, the components 205, 210, 215, and 220 may each provide a software module configured to provide the functions described herein. Of course one of ordinary skill in the art will recognize that the components 205, 210, 215, and 220 may be combined (or further subdivided) to suit the needs of a particular case.

In one embodiment, the BG/FG component 205 may be configured to separate each frame of video provided by the video input source 105 into a stationary or static part (the background scene) and a collection of volatile parts (the foreground scene). The frame itself may include a two-dimensional array of pixel values for multiple channels (e.g., RGB channels for color video or grayscale channel or radiance channel for black and white video). The BG/FG component 205 may be configured to generate a mask used to identify which pixels of the scene have been determined to depict the foreground and, conversely, which pixels have been determined to depict the background. The BG/FG component 205 then identifies regions of the scene that contain the foreground scene (referred to as a foreground “blob” or “patch”) and the background scene and supplies this information to subsequent stages of the pipeline. The BG/FG component 205 also generates a field-of-view change signal that indicates when a field-of view-change has occurred. The field-of-view change signal may be used by the machine learning engine 140 to save any learning developed for the current field-of-view and initiate or resume learning for the new or restored field-of-view. This ability to continue the learning process for a field-of-view rather than start over each time the field-of-view changes improves the ability of the system to quickly classify objects and behaviors and learn from previously observed patterns to identify normal and/or abnormal events.

A gallery of scene presets that each represent a previously captured background scene, referred to as a scene preset that may be stored in the preset storage 207. Each scene preset corresponds to a different field-of-view and may include a location and orientation of a respective camera. Each background scene is compared with the gallery of scene presets to identify a scene preset that matches the current background scene or to create a new scene preset. When a field-of-view change is detected a scene preset corresponding to the field-of-view is identified and compared with incoming background scenes.

The tracker component 210 may receive the foreground patches produced by the BG/FG component 205 and generate computational models for the patches. The tracker component 210 may be configured to use this information, and each successive frame of raw-video, to attempt to track the motion of the objects depicted by the foreground patches as they move about the scene.

The estimator/identifier component 215 may receive the output of the tracker component 210 (and the BF/FG component 205) and classify each tracked object as being one of a known category of objects. For example, in one embodiment, estimator/identifier component 215 may classify a tracked object as being a “person,” a “vehicle,” an “unknown,” or an “other.” In this context, the classification of “other” represents an affirmative assertion that the object is neither a “person” nor a “vehicle.” Additionally, the estimator/identifier component may identify characteristics of the tracked object, e.g., for a person, a prediction of gender, an estimation of a pose (e.g., standing or sitting) or an indication of whether the person is carrying an object.

The context processor component 220 may receive the output from other stages of the pipeline (i.e., the tracked objects, the background scene and foreground patches, and the results of the estimator/identifier component 215). Using this information, the context processor 220 may be configured to generate a stream of context events regarding objects tracked (by tracker component 210) and classified (by estimator identifier component 215). For example, the context processor component 220 may evaluate a foreground object from frame-to-frame and output context events describing that object's height, width (in pixels), position (as a 2D coordinate in the scene), acceleration, velocity, orientation angle, etc.

The computer vision engine 135 may take the outputs of the components 205, 210, 215, and 220 describing the motions and actions of the tracked objects in the scene and supply this information to the machine learning engine 140. In one embodiment, the primitive event detector 212 may be configured to receive the output of the computer vision engine 135 (i.e., the video images, the object classifications, and context event stream) and generate a sequence of primitive events—labeling the observed actions or behaviors in the video with semantic meaning. For example, assume the computer vision engine 135 has identified a foreground object and classified that foreground object as being a vehicle and the context processor component 220 estimates the kinematic data regarding the car's position and velocity. In such a case, this information is supplied to the machine learning engine 140 and the primitive event detector 212. In turn, the primitive event detector 212 may generate a semantic symbol stream providing a simple linguistic description of actions engaged in by the vehicle. For example, a sequence of primitive events related to observations of the computer vision engine 135 occurring at a parking lot could include formal language vectors representing the following: “vehicle appears in scene,” “vehicle moves to a given location,” “vehicle stops moving,” “person appears proximate to vehicle,” “person moves,” person leaves scene” “person appears in scene,” “person moves proximate to vehicle,” “person disappears,” “vehicle starts moving,” and “vehicle disappears.” As described in greater detail below, the primitive event stream may be supplied to excite the perceptual associative memory 230.

Illustratively, the machine learning engine 140 includes a long-term memory 225, a perceptual memory 230, an episodic memory 235, a workspace 240, codelets 245, and a mapper component 211. In one embodiment, the perceptual memory 230, the episodic memory 235, and the long-term memory 225 are used to identify patterns of behavior, evaluate events that transpire in the scene, and encode and store observations. Generally, the perceptual memory 230 receives the output of the computer vision engine 135 (e.g., the context event stream) and a primitive event stream generated by primitive event detector 212. The episodic memory 235 stores data representing observed events with details related to a particular episode, e.g., information describing time and space details related on an event. That is, the episodic memory 235 may encode specific details of a particular event, i.e., “what and where” something occurred within a scene, such as a particular vehicle (car A) moved to a location believed to be a parking space (parking space 5) at 9:43 AM.

The long-term memory 225 may store data generalizing events observed in the scene. To continue with the example of a vehicle parking, the long-term memory 225 may encode information capturing observations and generalizations learned by an analysis of the behavior of objects in the scene such as “vehicles tend to park in a particular place in the scene,” “when parking vehicles tend to move a certain speed,” and “after a vehicle parks, people tend to appear in the scene proximate to the vehicle,” etc. Thus, the long-term memory 225 stores observations about what happens within a scene with much of the particular episodic details stripped away. In this way, when a new event occurs, memories from the episodic memory 235 and the long-term memory 225 may be used to relate and understand a current event, i.e., the new event may be compared with past experience, leading to both reinforcement, decay, and adjustments to the information stored in the long-term memory 225, over time. In a particular embodiment, the long-term memory 225 may be implemented as an ART network and a sparse-distributed memory data structure.

The mapper component 211 may receive the context event stream and the primitive event stream and parse information to multiple ART networks to generate statistical models of what occurs in the scene for different groups of context events and primitive events.

Generally, the workspace 240 provides a computational engine for the machine learning engine 140. For example, the workspace 240 may be configured to copy information from the perceptual memory 230, retrieve relevant memories from the episodic memory 235 and the long-term memory 225, select and invoke the execution of one of codelets 245. In one embodiment, each codelet 245 is a software program configured to evaluate different sequences of events and to determine how one sequence may follow (or otherwise relate to) another (e.g., a finite state machine). More generally, the codelet may provide a software module configured to detect interesting patterns from the streams of data fed to the machine learning engine 140. In turn, the codelet 245 may create, retrieve, reinforce, or modify memories in the episodic memory 235 and the long-term memory 225. By repeatedly scheduling codelets 245 for execution, copying memories and percepts to/from the workspace 240, the machine learning engine 140 performs a cognitive cycle used to observe, and learn, about patterns of behavior that occur within the scene. Whenever a field-of-view and corresponding scene preset is restored, the cognitive cycle associated with the scene background model may be restored, improving the performance of the machine learning engine 140.

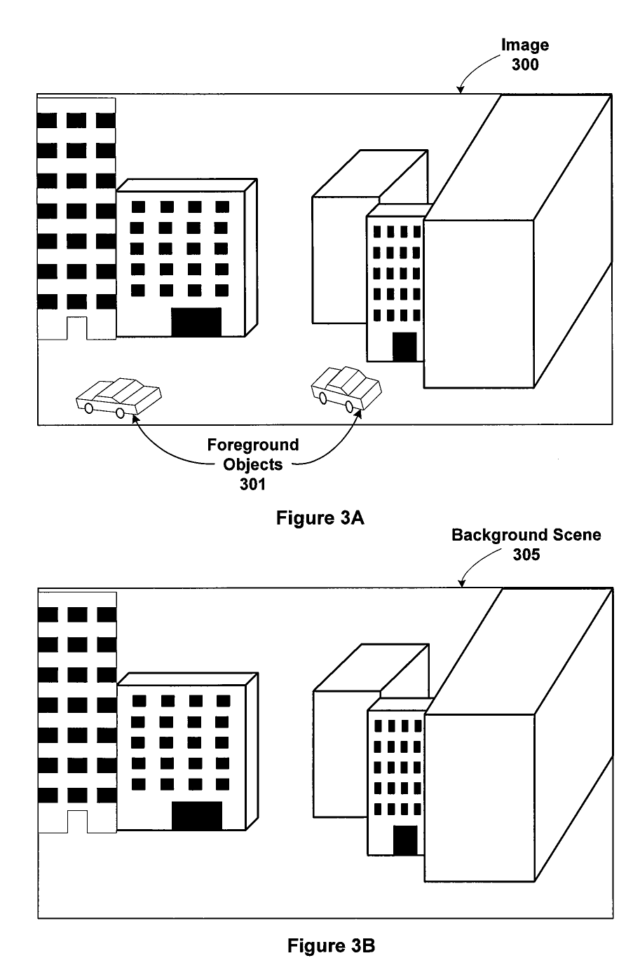

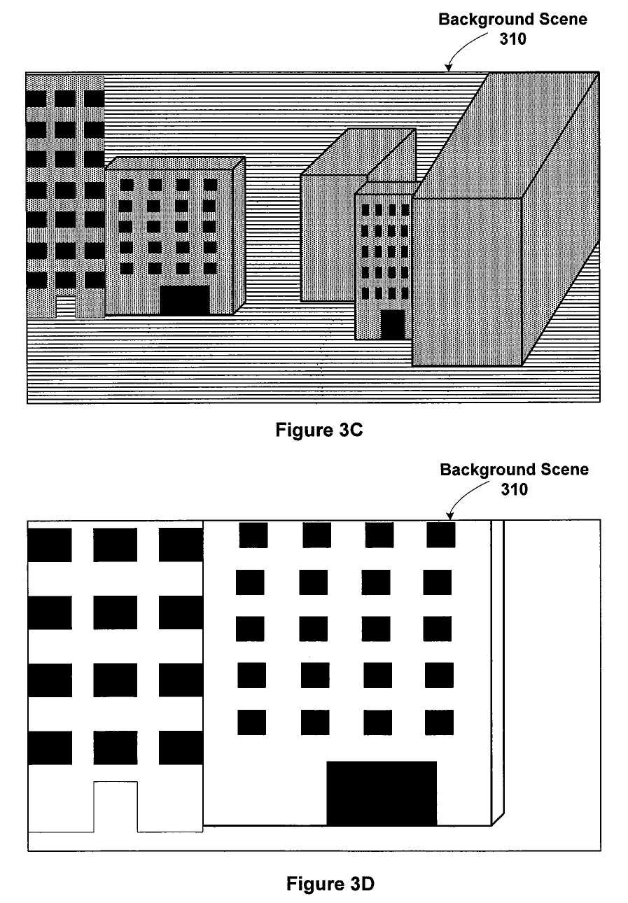

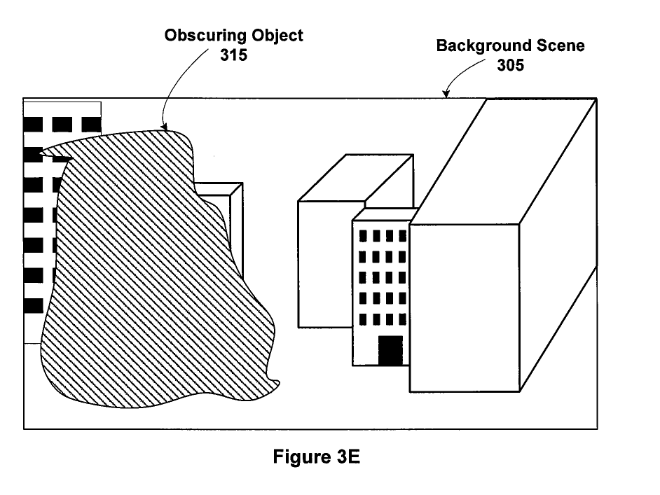

FIG. 3A illustrates an image 300 captured by a camera, according to one embodiment of the invention. The image 300 includes foreground objects 301 that are identified as a foreground patch by the BG/FG component 205. The BG/FG component 205 also identifies the background scene and determines if a field-of-view change has occurred. FIG. 3B illustrates the background scene 305 of the image 300 shown in FIG. 3A, according to one embodiment of the invention. FIG. 3C illustrates the background scene 310 that is the background scene 305 under different lighting conditions, according to one embodiment of the invention. Different lighting conditions may occur as the time transitions from day to night and night to day or when a camera capture mode is converted from color to near infrared or from near infrared to color. Additionally, the lighting conditions may vary due to a sudden illumination change resulting from car headlights or a flashlight aimed towards the camera. For any of these cases, it is desirable to identify background scene 305 and background scene 310 as the same field-of-view and not signal that a field-of-view change has occurred.

In some cases it may be desirable to match the same scene preset to the background scene 310 and the background scene 305 in order to use the learning developed for background scene 305 when background scene 310 is being observed. In other cases, it may be desirable to have separate scene presets for the background scene 310 and the background scene 305 since different behaviors occur during different times of the day.

FIG. 3D illustrates a changed field-of-view including background scene 310 that is a portion of the background scene 305, according to one embodiment of the invention. When the camera position changes systematically due to one or more of a pan, tilt, or zoom movement a field-of-view change should be detected. Therefore, when the camera position is moved to transition between background scene 310 and background scene 305 a field-of-view change is detected. In contrast, when the camera position changes due to wind or tremors that cause the camera to wobble, a field-of-view change should not be detected.

FIG. 3E illustrates a view of the background scene 305 that is partially obstructed by an obscuring object 315, according to one embodiment of the invention. When the obscuring object 315 is introduced into the background scene 305, it is desirable to determine that a field-of-view change has not occurred. A field-of-view detection technique that is robust in terms of changes in illumination and changes in the background content allows for the system to restore learning associated with a stored scene preset and field-of-view and continue to learn rather than begin learning by creating a new scene preset and background model for a new field-of-view. However, when background scene 305 is completely obstructed or the video feed is disconnected, it is desirable to indicate that a field-of-view change has occurred.

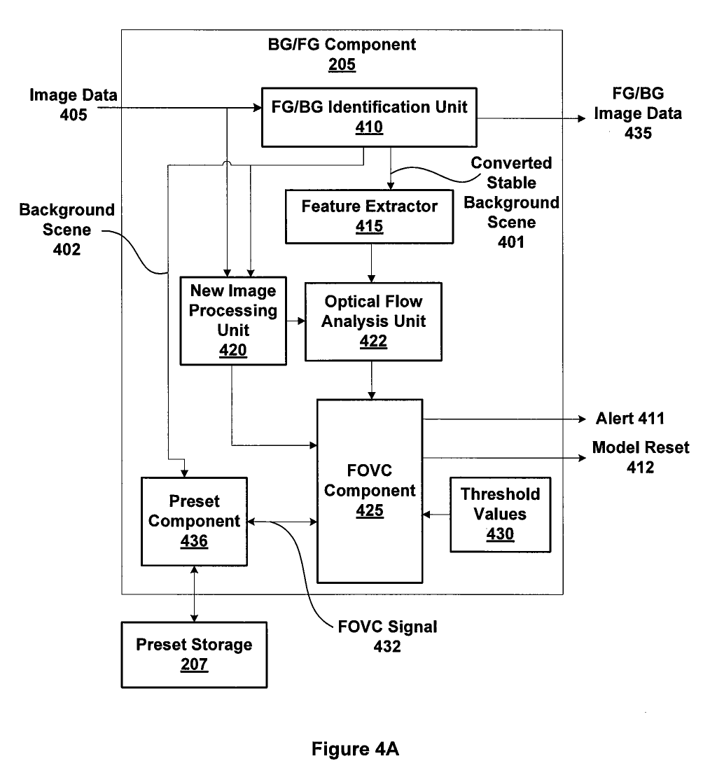

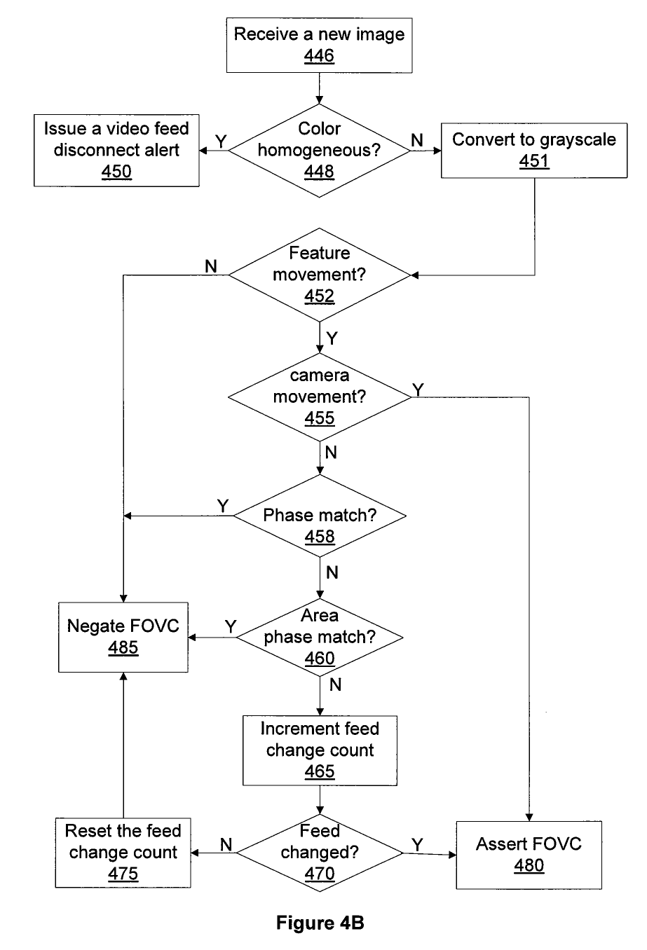

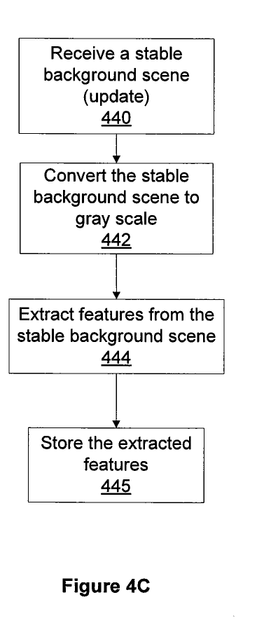

FIG. 4A illustrates units of the BG/FG component 205 shown in FIG. 2, according to one embodiment of the present invention. The BG/FG component 205 is coupled to the preset storage 207 and includes a FG/BG identification unit 410, a feature extractor 415, an optical flow analysis unit 422, a new image processing unit 420, a field-of-view change (FOVC) component 425, a preset component 436, and threshold values 430. The FG/BG identification unit 410 extracts the foreground patch and the background scene from the image data 405 and outputs the foreground patch and the background scene as the FG/BG image data 435. The FG/BG image data 435 may also include scene preset identifier that is used by the machine learning engine 140 to restore learning data for the scene preset.

The FG/BG identification unit 410 outputs each new background scene that is extracted as new background scene 402. When a background model of a field-of-view has matured after a given amount of time, an extracted background scene is identified as a stable background scene, converted to gray scale representation to produce a converted stable background scene 401, and output by the FG/BG identification unit 410 to the feature extractor 415. The converted stable background scene 401 is updated periodically, e.g., every N frames or N seconds, and provided periodically to the feature extractor 415. Conversion of the stable background scene to gray scale reduces or eliminates the number of false positive field-of-view changes that are detected due to camera capture mode transitions from color to near infrared and near infrared to color.

The feature extractor 415 extracts features, e.g., Harris corner pixels, edge pixels, and the like, from the converted stable background scene 401 using techniques known to those skilled in the art. The extracted features may be stored for each updated converted stable background scene 401. Each extracted feature is associated with a position of a pixel in the converted stable background scene 401. The extracted features are output to the optical flow analysis unit 422 and used to produce tracking results that are output to FOVC component 425.

The new image processing unit 420 determines if the new image received via image data 405 is homogeneous, i.e., all of the pixels are the same color, indicating that no video feed is present. When the new image is homogeneous, the FOVC component 425 issues a “video feed disconnected” event via alert 411 and no further processing of the new image and the converted stable background scene 401 is performed until a new image is received that is not homogeneous. When the new image processing unit 420 determines that the new image is not homogeneous, the new image is converted to gray scale representation to produce a converted new image that is output to the optical flow analysis unit 422.

The optical analysis unit 422 tracks the extracted features in the converted new image to produce tracking results that are output to the FOVC component 425. The tracking results may be represented in a polar coordinate system. When the tracking results indicate that a majority of the extracted features are in the same pixel positions in the converted stable background scene 401 and the converted new image then there is no potential field-of-view change. The FOVC component 425 negates the field-of-view change signal and negates the model reset 412 so that the machine learning engine 140 will continue to use the current background model. The majority may be specified by a threshold value that is stored in the threshold values 430. For example, a majority of the extracted features may be 80%, so the threshold would be specified as 80% of the extracted features and when 80% of the extracted features are in the same pixel positions in the converted stable background scene 401 and the converted new image no field-of-view change is detected.

When the tracking results indicate that the majority of the extracted features are not in the same pixel positions in the converted stable background scene 401 and they are in the converted new image then there is a potential field-of-view change and the FOVC component 425 determines if a majority extracted features have moved in a systematic or orderly fashion. Movement in a systematic or orderly fashion indicates that the pan, tilt, or zoom of the camera capturing the video feed has changed and that a field-of-view change has occurred.

When the tracking results indicate the majority of the extracted features are lost or moved, but not moved in an orderly fashion, then it is possible that there has been a sudden change in the scene illumination or that the camera is out-of-focus. Since the extracted features are illumination dependent, the phase spectra of the converted stable background scene 401 and the converted new image are used to determine if a field-of-view change has occurred. The FOVC component 425 computes the phase spectrum of the converted stable background scene 401 and the phase spectrum of the converted new image to produce a first and second phase spectrum. When the first and second phase spectra match, then the field-of-view has not changed and the FOVC signal 432 is negated. A phase match threshold may be specified and stored in threshold values 430 to define a tolerance for the phase match.

When the first and second phase spectra do not match, then it is possible that a field-of-view change has occurred due to a video feed change. In order to determine whether or not a video feed change has occurred, the FOVC component 425 extracts only the background areas from the converted stable background scene 401 and the converted new image. The foreground patch of the new image is used to extract the background areas. Since the foreground patch of the new image may be different than the corresponding foreground patch for the stable background scene, the background area of the converted stable background scene may be different than the converted stable background scene. Using the foreground patch of the new image removes features that are lost in the new image from the stable background scene. The FOVC component 425 computes the phase spectrum of the background area of the converted stable background scene 401 and the phase spectrum of the background area of the converted new image to produce a third and fourth background area phase spectrum. When the third and fourth background area phase spectra match, then background features are lost or moved due to a major obstruction of the scene. The field-of-view has not changed and the FOVC signal 432 is negated. A background area phase match threshold may be specified and stored in threshold values 430 to define a tolerance for the background area phase match.

When the third and fourth background area phase spectra do not match according to the background area phase match threshold, then there is a potential field-of-view change due to a video feed change. A video feed change may occur when the video feed is switched to a different camera or when the camera has moved to a different position. In order to confirm that an actual field-of-view change has occurred due to a video feed change, the FOVC component 425 processes additional new images. The FOVC component 425 asserts the FOVC signal 432 when a count of potential video feed change events reaches a predetermined threshold for successive new images in the video feed.

Using these techniques, the BG/FG component 205 is able to differentiate between a new or changed scene and a temporary variation in the scene to accurately detect field-of-view changes for the video feed. A field-of-view change is detected when the position of a camera providing the video feed changes, the video feed is switched to a different camera, the video feed is disconnected, or the camera providing the video feed is obscured. A false-positive field-of-view change is not detected when the scene changes due to a sudden variation in illumination, obstruction of a portion of the camera providing the video feed, blurred images due to an out-of-focus camera, or a transition between bright and dark light when the video feed transitions between color to near infrared capture modes. When a field-of-view change is detected, a model reset 412 is asserted so that an existing background model corresponding to the new position is identified or a new background model is created. Similarly, the preset component 436 receives the FOVC signal 432 and identifies and restores an existing preset background scene from preset storage 207 or creates a new preset background scene. Learning that was previously generated by the machine learning engine 140 for an existing background model may be restored.

FIG. 4B illustrates a method for detecting a field-of-view change, according to one embodiment of the invention. As shown, the method begins at step 446 where a new image is received by the new image processing unit 420. At step 448, the new image processing unit 420 determines if the color of the new image received via image data 405 is homogeneous, i.e., all of the pixels are the same color, indicating that no video feed is present. When the new image processing unit 420 determines that the color of the new image received via image data 405 is homogeneous, then in step 450, the FOVC component 425 issues a “video feed disconnected” event via alert 411 and no further processing of the new image and the converted stable background scene 401 is performed until a new non-homogeneous image is received. When the new image processing unit 420 determines that the color of the new image is not homogeneous, at step 451, the new image is converted to gray scale representation to produce a converted new image that is output to the optical flow analysis unit 422.

At step 452, the optical flow analysis unit 422 produces tracking results and the FOVC component 425 determines whether or not a majority of the features have moved. The majority may be specified by a threshold value that is stored in the threshold values 430. When a majority of the extracted features are in the same pixel positions in the converted stable background scene and the converted new image, the FOVC component determines that a majority of the features have not moved and at step 485 the FOVC component 425 negates the field-of-view change signal.

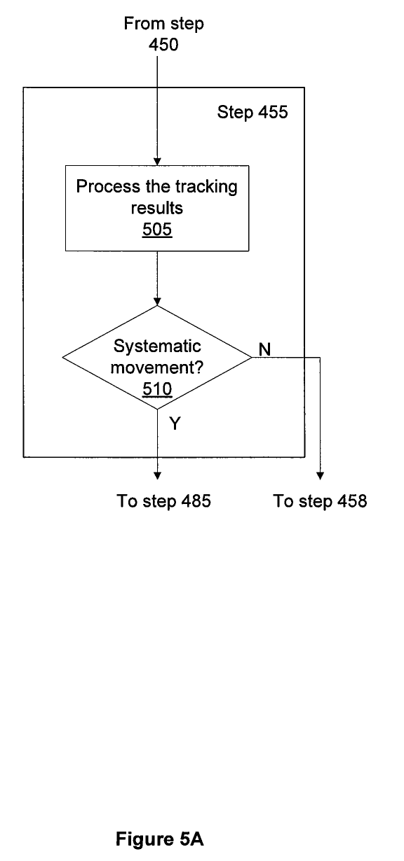

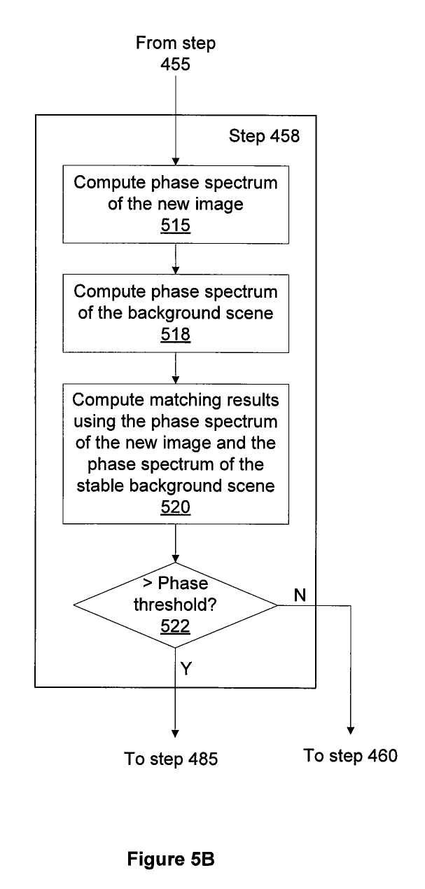

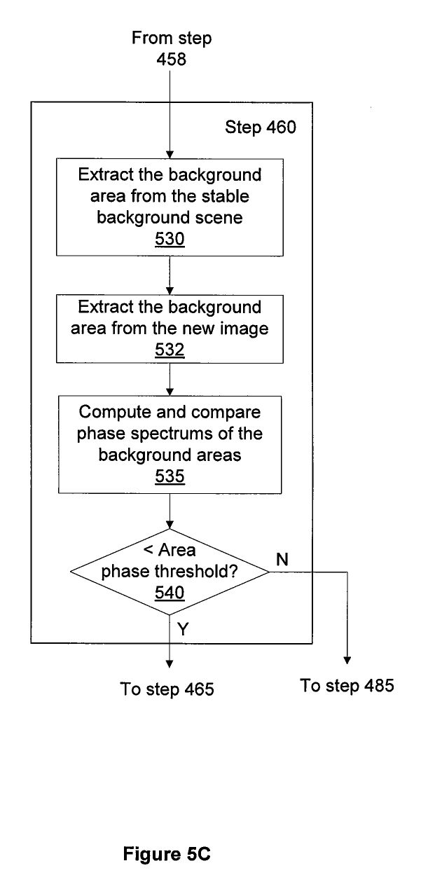

When the tracking results indicate that the majority of the extracted features are not in the same pixel positions in the converted stable background scene 401 as they are in the converted new image, then there is a feature movement (a potential field-of-view change) and the FOVC component 425 proceeds to step 455. At step 455 the FOVC component 425 determines if a majority extracted features have moved in a systematic or orderly fashion, indicating a camera movement. Step 455 is described in detail in conjunction with FIG. 5A. If, in step 455, a camera movement has occurred, then at step 480 the FOVC component 425 asserts the field-of-view change signal.

Otherwise, at step 458, the FOVC component 425 determines if the phase spectra of the converted stable background scene 401 and the converted new image match, and, if so, then the field-of-view has not changed and at step 485 the FOVC component 425 negates the FOVC signal 432. Step 458 is described in detail in conjunction with FIG. 5B. Otherwise, at step 460 the FOVC component 425 determines if the phase spectrum of the background area of the converted stable background scene 401 and the phase spectrum of the background area of the converted new image match, and, if so, then at step 485 the FOVC component 425 negates the FOVC signal 432. Step 460 is described in detail in conjunction with FIG. 5C. Otherwise, at step 465 there is a potential field-of-view change due to a video feed change and hence a count of potential video feed change events, feed change count, is incremented. At step 470, the FOVC component 425 determines if the feed change count has reached a predetermined value indicating that the video feed has changed. When the FOVC component 425 determines that the video feed has not necessarily changed, then at step 475 the FOVC component 425 resets the feed change count and at step 485 the FOVC component 425 negates the FOVC signal 432. Otherwise, at step 480 the FOVC component 425 asserts the FOVC signal 432.

FIG. 4C illustrates a method for extracting features from a stable background scene or updated stable background scene, according to one embodiment of the invention. As shown, the method begins at step 440 where a stable background scene or a stable background scene update is received by the feature extractor 415. At step 442, the feature extractor 415 converts the stable background scene to gray scale representation to produce a converted stable background scene. The converted stable background scene is updated periodically, e.g., every N frames or N seconds, and provided periodically to the feature extractor 415. At step 444, the feature extractor 415 extracts features, e.g., Harris corner pixels, edge pixels, and the like, from the converted stable background scene using techniques known to those skilled in the art. At step 445, the extracted features are stored for the converted stable background scene. Each extracted feature is associated with a position of a pixel in the converted stable background scene. As previously described, the extracted features are output to the optical flow analysis unit 422 and used to produce tracking results that are output to FOVC component 425.

FIG. 5A illustrates a method for performing step 455 of FIG. 4B to determine if a camera movement threshold is exceeded and changed the field-of-view, according to one embodiment of the invention. At step 505, the FOVC component 425 receives the tracking results which include vectors associated with the extracted features. The vectors indicate the movement of each of the extracted features between the converted stable background scene and the converted new image. When the vectors are graphed in a polar coordinate system, the movement of the extracted features may be determined to be systematic when the vectors lie within a defined portion of the graph. In particular, the vectors in the defined portion of the graph are clustered between given magnitude and angle bounds when the camera pans or tilts. When the camera zooms the vectors move radially out or in. At step 510, the FOVC component 425 determines if the movement of the extracted features is systematic based on the vectors. When the movement is systematic, the FOVC component 425 proceeds to step 485. Otherwise, the FOVC component 425 proceeds to step 458.

FIG. 5B illustrates a method for performing step 458 of FIG. 4B, according to one embodiment of the invention. Phase spectrum analysis is used to determine if matching results indicate a change in scene illumination, a blurred scene due to an out-of-focus camera, or a major obstruction of the scene. At step 515, the FOVC component 425 computes the phase spectrum of the converted new image to produce a first phase spectrum. At step 518, the FOVC component 425 computes the phase spectrum of the converted stable background scene to produce a second phase spectrum. The following equations may be used to compute the phase spectra.

First phase spectrum=pᵣ=angle(fft(Xᵣ)) (equ. 1)

Second phase spectrum=p_{b}=angle(fft(X_{b})) (equ. 2)

Xᵣ represents the converted new image, X_{b} represents the converted stable background scene, and fft(.) denotes the fast Fourier transform, while angle(.) denotes the extraction of phase from the Fourier transform.

Note that these phase spectra are computed from real-valued input images. Therefore, by definition of Fourier transform calculation, each phase value will find itself in two different places in the corresponding matrix. More specifically, one half of the data in the phase spectrum is a duplicate of another and is therefore redundant. Thus, one erroneous phase value will be reflected in two elements in the phase spectrum matrix. To avoid this propagation of error into the matching algorithm, it is important to compute inverse Fourier transforms of the first and second phase spectra with unit magnitude as follows.

IFFT of First phase spectrum=\hat{X}r=real(ifft(e^{j pr}) (equ. 3)

IFFT of Second phase spectrum=\hat{X}b=real(fft(e^{j pb})) (equ. 4)

ilfft(.) denotes the inverse Fourier transform and real(.) denotes the real part of the inverse Fourier transform. By computing the inverse transforms of unit-magnitude phase spectra of images, the redundancy present in the original phase spectra is removed. In additional, the structures in the scene may be reliably compared in the spatial domain to determine whether or not the first and second phase spectra match.

At step 520, the FOVC component 425 compares the first and second phase spectra to produce matching results. Note that the row-scanned inverse Fourier transforms, Xr and Xb are both unit-norm vectors with magnitudes of 1. A simple dot product between the Xr and Xb can be used to compare the converted new image with the converted stable background scene and produce matching results using the following equation.

{circumflex over (\vec{X}r·{circumflex over (\vec{X}b (equ. 5)

When the matching results are greater than a phase threshold at step 522, then the field-of-view has not changed and at step 485 the FOVC signal 432 is negated. The range of the dot products output is [−1,1] and the phase threshold value may be set to 0.15. Matching results that are greater than the phase threshold indicate a sudden change in illumination or an out-of-focus camera. In contrast, matching results that are not greater than the phase threshold indicate a video feed change or major obstruction of the scene. When the matching results are not greater than a phase threshold at step 522, then the first and second phase spectra are not within a phase threshold value of each other at step 522. Since the field-of-view may have changed due to a video feed change, the FOVC component 425 proceeds to step 460 to differentiate between a video feed change and a major obstruction of the scene.

FIG. 5C illustrates a method for performing step 460 of FIG. 4B to determine if phase matching results indicate that the scene is obstructed and a field-of-view change has not occurred, according to one embodiment of the invention. At step 530, the FOVC component 425 extracts only the background area from the converted stable background scene. At step 532, the FOVC component 425 extracts only the background area from the converted new image. At step 535, the FOVC component 425 computes the phase spectrum of the background area of the converted stable background scene and the phase spectrum of the background area of the converted new image to produce a third and fourth background area phase spectrum. Previously shown equations 1-4 may be used to compute the third and fourth phase spectra. Let the corresponding row-scanned inverse Fourier transforms of the background area of the converted stable background scene and the phase spectrum of the background area of the converted new image with unit magnitudes be denoted {circumflex over (\vec{X}ᵣ^{b} and {circumflex over (\vec{X}ᵣ^{r}, and the ratio of the pixels in the converted stable background scene to the total number of pixels be denoted η.

The FOVC component 425 then compares the third and fourth phase spectra to produce area matching results. The following equation may be used to compute area matching results to differentiate between a major obstruction and a potential video feed change.

η({circumflex over (\vec{X}ᵣ^{b}·{circumflex over (\vec{X}ᵣ^{r}) (equ. 6))

When the matching results are not less than an area phase threshold at step 540, then the field-of-view has not changed and at step 485 the FOVC signal 432 is negated. When the area matching results are not less than the area phase threshold a major obstruction is present in the new image. Note that above row-scanned inverse Fourier transforms {circumflex over (\vec{X}ᵣ^{b} and {circumflex over (\vec{X}ᵣ^{r}, are also unit-norm vectors and hence the range of their dot product is [−1,1]. The range of η is [0,1]. Hence the area matching results will have a range of [−1,1]. The area phase threshold may be set to 0.15. When the matching results are less than an area phase threshold at step 540, then the field-of-view may have changed due to a video feed change and the FOVC component 425 proceeds to step 465. In order to confirm that an actual field-of-view change has occurred due to a video feed change, the FOVC component 425 processes additional new images. The FOVC component 425 asserts the FOVC signal 432 when a count of potential video feed change events reaches a predetermined threshold for successive new images in the video feed.

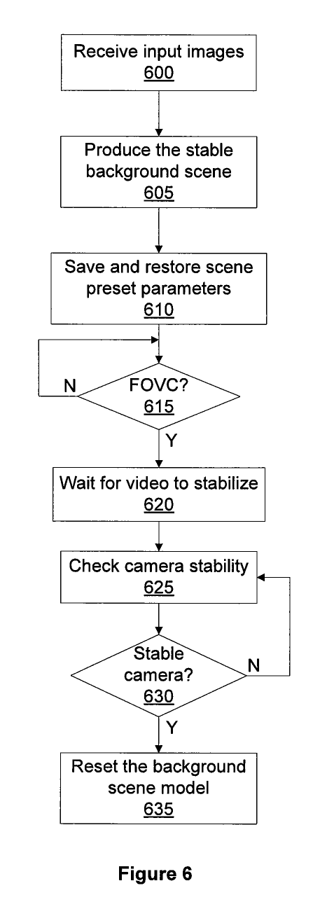

FIG. 6 illustrates a method for using the field-of-view change detection to save and restore learning developed for a scene, according to one embodiment of the invention. As shown, the method begins at step 600 where input images are received by the behavior recognition system 100. At step 605 the BG/FG component 205 produces the stable background scene. At step 610 preset parameters associated with the previous stable background scene are stored and preset parameters associated with the new stable background scene are restored. At step 615, the BG/FG component 205 determines whether or not a field-of-view change is detected, and, if not, step 615 is repeated. When a field-of-view change is detected, at step 620 the behavior recognition system 100 waits for the video feed to stabilize. At step 625, the behavior recognition system 100 checks the camera stability. At step 630, the behavior recognition system 100 determines whether or not the camera is stable, and, if not, the behavior recognition system 100 returns to step 625. Otherwise, in step 635 the background scene model is reset.

Advantageously, techniques for detecting a field-of-view change for a video feed described herein allow a computer vision engine to differentiate between a new or changed scene and a temporary variation in the scene to accurately detect field-of-view changes for the video feed. A field-of-view change is detected when the position of a camera providing the video feed changes, the video feed is switched to a different camera, the video feed is disconnected, or the camera providing the video feed is obscured. A false-positive field-of-view change is not detected when the scene changes due to a sudden variation in illumination, obstruction of a portion of the camera providing the video feed, blurred images due to an out-of-focus camera, or a transition between bright and dark light when the video feed transitions between color to near infrared capture modes. When a field-of-view change is detected a background model corresponding to the new position is identified and any learning that was previously generated by the machine learning engine may be restored. This ability to continue the learning process for a previously used camera position rather than start over each time the field-of-view changes improves the ability of the system to quickly classify objects and behaviors and learn from previously observed patterns to identify normal and/or abnormal events.

While the foregoing is directed to embodiments of the present invention, other and further embodiments of the invention may be devised without departing from the basic scope thereof, and the scope thereof is determined by the claims that follow.

What is claimed is:

1. A computer-implemented method for detecting a field-of-view change for a video feed, comprising:
receiving a stable background scene acquired from a plurality of images of the video feed;
receiving a new image from the video feed;
converting the stable background scene to a gray scale representation to produce a converted stable background scene;
extracting features representing image characteristics from the converted stable background scene to produce extracted features, wherein each extracted feature is associated with a position of a pixel; and
producing a field-of-view change signal that indicates if a field-of-view change has occurred in the video feed based on the extracted features, the converted stable background scene, and the new image.

2. The computer-implemented method of claim 1, further comprising converting the new image to a gray scale representation to produce a converted new image that is also used to produce the field-of-view change signal.

3. The computer-implemented method of claim 1, further comprising:
performing an optical flow analysis of the extracted features in the new image to produce tracking results; and
negating the field-of-view change signal to indicate that a field-of-view change has not occurred when the tracking results indicate that a feature movement threshold is not exceeded.

4. The computer-implemented method of claim 1, further comprising:
performing an optical flow analysis of the extracted features in the new image to produce tracking results; and
asserting the field-of-view change signal to indicate that a field-of-view change has occurred due to camera pan, tilt, or zoom when the tracking results indicate that a camera movement threshold is exceeded and the extracted features are moved in a systematic or orderly fashion based on locations of the extracted features in a polar coordinate system.

5. The computer-implemented method of claim 1, further comprising determining that the new image includes at least two colors and is not homogeneous.

6. The computer-implemented method of claim 1, further comprising:
determining that the new image includes single color and is homogeneous; and
indicating that the video feed is disconnected.

7. The computer-implemented method of claim 1, further comprising:
updating the stable background scene; and
repeating the extracting of the features to update the extracted features based on the updated stable background scene.

8. The computer-implemented method of claim 1, further comprising:
computing a phase spectrum of the converted stable background scene;
converting the new image to a gray scale representation to produce a converted new image;
computing a phase spectrum of the converted new image;
comparing the phase spectrum of the converted stable background scene to the phase spectrum of the new image to produce matching results; and
negating the field-of-view change signal to indicate that a field-of-view change has not occurred when the matching results indicate that a phase threshold is not exceeded.

9. The computer-implemented method of claim 1, further comprising:
extracting a first background area of the converted stable background scene that excludes foreground objects of the new image;
computing a phase spectrum of the first background area;
converting the new image to a gray scale representation to produce a converted new image;
extracting a second background area of the converted new image that excludes the foreground objects of the new image;
computing a phase spectrum of the second background area;
comparing the phase spectrum of the first background area to the phase spectrum of the second background area to produce background area matching results; and
negating the field-of-view change signal to indicate that a field-of-view change has not occurred when the background area matching results indicate that an area phase threshold is equaled or exceeded.

10. The computer-implemented method of claim 1, further comprising:
extracting a first background area of the converted stable background scene that excludes foreground objects of the new image;
computing a phase spectrum of the first background area;
converting the new image to a gray scale representation to produce a converted new image;
extracting a second background area of the converted new image that excludes the foreground objects of the new image;
computing a phase spectrum of the second background area;
comparing the phase spectrum of the first background area to the phase spectrum of the second background area to produce background area matching results; and
asserting the field-of-view change signal to indicate that a field-of-view change has occurred when the background area matching results indicate that an area phase threshold is not equaled or exceeded for a predetermined length of time.

11. A computer-readable storage medium containing a program which, when executed by a processor, performs an operation for detecting a field-of-view change for a video feed, the operation comprising:
receiving a stable background scene acquired from a plurality of images of the video feed;
receiving a new image from the video feed;
converting the stable background scene to a gray scale representation to produce a converted stable background scene;
extracting features representing image characteristics from the converted stable background scene to produce extracted features, wherein each extracted feature is associated with a position of a pixel; and
producing a field-of-view change signal that indicates if a field-of-view change has occurred in the video feed based on the extracted features, the converted stable background scene, and the new image.

12. The computer-readable storage medium of claim 11, further comprising converting the new image to a gray scale representation to produce a converted new image that is also used to produce the field-of-view change signal.

13. The computer-readable storage medium of claim 11, further comprising:
performing an optical flow analysis of the extracted features in the new image to produce tracking results;
negating the field-of-view change signal to indicate that a field-of-view change has not occurred when the tracking results indicate that a feature movement threshold is not exceeded; and
asserting the field-of-view change signal to indicate that a field-of-view change has occurred due to camera pan, tilt, or zoom when the tracking results indicate that a camera movement threshold is exceeded and the extracted features are moved in a systematic or orderly fashion based on locations of the extracted features in a polar coordinate system.

14. The computer-readable storage medium of claim 11, further comprising:
computing a phase spectrum of the converted stable background scene;
converting the new image to a gray scale representation to produce a converted new image;
computing a phase spectrum of the converted new image;
comparing the phase spectrum of the converted stable background scene to the phase spectrum of the new image to produce matching results; and
negating the field-of-view change signal to indicate that a field-of-view change has not occurred when the matching results indicate that a phase threshold is not exceeded.

15. The computer-readable storage medium of claim 11, further comprising:
extracting a first background area of the converted stable background scene that excludes foreground objects of the new image;
computing a phase spectrum of the first background area;
converting the new image to a gray scale representation to produce a converted new image;
extracting a second background area of the converted new image that excludes the foreground objects of the new image;
computing a phase spectrum of the second background area;
comparing the phase spectrum of the first background area to the phase spectrum of the second background area to produce background area matching results;
negating the field-of-view change signal to indicate that a field-of-view change has not occurred when the background area matching results indicate that an area phase threshold is equaled or exceeded; and
asserting the field-of-view change signal to indicate that a field-of-view change has occurred when the background area matching results indicate that an area phase threshold is not equaled or exceeded for a predetermined length of time.

16. A system, comprising:
a video input source configured to capture images included in the video feed;
a processor; and
a memory containing a program, which, when executed on the processor is configured to perform an operation for detecting a field-of-view change for the video feed, the operation comprising:
receiving a stable background scene acquired from a plurality of images of the video feed;
receiving a new image from the video feed;
converting the stable background scene to a gray scale representation to produce a converted stable background scene;
extracting features representing image characteristics from the converted stable background scene to produce extracted features, wherein each extracted feature is associated with a position of a pixel; and
producing a field-of-view change signal that indicates if a field-of-view change has occurred in the video feed based on the extracted features, the converted stable background scene, and the new image.

17. The system of claim 16, the operation further comprising converting the new image to a gray scale representation to produce a converted new image that is also used to produce the field-of-view change signal.

18. The system of claim 16, the operation further comprising:
performing an optical flow analysis of the extracted features in the new image to produce tracking results;
negating the field-of-view change signal to indicate that a field-of-view change has not occurred when the tracking results indicate that a feature movement threshold is not exceeded; and
asserting the field-of-view change signal to indicate that a field-of-view change has occurred due to camera pan, tilt, or zoom when the tracking results indicate that a camera movement threshold is exceeded and features are moved in a systematic or orderly fashion based on their locations in the polar coordinate system.

19. The system of claim 16, the operation further comprising:
computing a phase spectrum of the converted stable background scene;
converting the new image to a gray scale representation to produce a converted new image;
computing a phase spectrum of the converted new image;
comparing the phase spectrum of the converted stable background scene to the phase spectrum of the new image to produce matching results; and
negating the field-of-view change signal to indicate that a field-of-view change has not occurred when the matching results indicate that a phase threshold is not exceeded.

20. The system of claim 16, the operation further comprising:
extracting a first background area of the converted stable background scene that excludes foreground objects of the new image;
computing a phase spectrum of the first background area;
converting the new image to a gray scale representation to produce a converted new image;
extracting a second background area of the converted new image that excludes the foreground objects of the new image;
computing a phase spectrum of the second background area;
comparing the phase spectrum of the first background area to the phase spectrum of the second background area to produce background area matching results;
negating the field-of-view change signal to indicate that a field-of-view change has not occurred when the background area matching results indicate that an area phase threshold is equaled or exceeded; and
asserting the field-of-view change signal to indicate that a field-of-view change has occurred when the background area matching results indicate that an area phase threshold is not equaled or exceeded for a predetermined length of time.
